(19) United States
(12) Patent Application Publication
(10) Pub. No.: US 2023/0360069 A1
(43) Pub. Date: Nov. 9, 2023

(54) SYSTEM AND METHOD FOR DETERMINING POTENTIAL USERS AND MARKET STOCK KEEPING UNIT IN RETAIL E-COMMERCE ENVIRONMENT

(71) Applicant: Flipkart Internet Private Limited, Bengaluru (IN)

(72) Inventors: Sanjana B. Pattanshetti, Bengaluru (IN); Harshvardhan Dilip Jadhav, Bengaluru (IN); Abhishek Kumar, Bengaluru (IN); Abhishek Bose, Bengaluru (IN); Rishi Singh, Bengaluru (IN); Sarath Govindarajan, Bengaluru (IN)

(21) Appl. No.: 17/871,446

(22) Filed: Jul. 22, 2022

(30) Foreign Application Priority Data
May 7, 2022 (IN) 202241026521

(51) Int. Cl. G06Q 30/02

(52) U.S. Cl. CPC G06Q 30/0204

(57) ABSTRACT

A system and method for for determining potential users and potential Market Stock Keeping Unit (MSKU) in retail e-commerce environment is provided. The method includes receiving user data including one or more parameters from a database of a retail e-commerce environment; categorizing different types of user based on an affluence segment criteria; tagging different types of users based on the categorization; computing a market share of potential users for a MSKU; benchmarking, the computed market share of potential users for the MSKU with respect to a market share of the potential users in the super-categories of the MSKU; tagging the MSKU into different types of the MSKU, based on a pre-defined benchmark index and pre-defined threshold values corresponding to at least one of, the market share of potential users for the MSKU and the benchmarking of the MSKU; and outputting the tagged potential users and the tagged potential MSKU.

### TECHNICAL FIELD

The present disclosure relates in general to categorization of users of a retail e-commerce environment.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

E-commerce environments generally have a database of customers who use their services. In order to improve market penetration, there is a need to understand customer behaviour and preferences in order to provide suggestions or recommendations for their shopping requirements. Conventionally, price affinity of users are used to understand customer preferences. However, price affinity is an insufficient parameter as it does not fully represent a thought process of a user wishing to make a purchase on the platform.

There is therefore, a requirement for an approach to better understand user expectations and preferences.

### SUMMARY

It is an object of the present invention to provide a system and a method for determining potential users and market stock keeping unit in retail e-commerce environment.

It is another object of the present invention to provide a system and method for categorizing users to better understand user behaviour and preferences.

It is another object of the present invention to provide a system and method to more accurately determine user behaviour and preferences.

In a first aspect, the present disclosure provides a method for determining potential users and potential market stock keeping unit (MSKU) in retail e-commerce environment. The method includes receiving, by a processor associated with a potentiality identification system, user data including one or more parameters from a database of a retail e-commerce environment. The one or more parameters includes at least one of a price affinity, a brand, and a mode of payment. The method further includes categorizing, by the processor, different types of user based on an affluence segment criteria, upon receiving the user data. The method further includes tagging, by the processor, different types of users based on the categorization. The different types of users include at least one of a potential user, an emerging potential user, a mass user, and an entry level user. The method further includes computing, by the processor, a market share of potential users for a Market Stock Keeping Unit (MSKU). The method further includes benchmarking, by the processor, the computed market share of potential users for the MSKU with respect to a market share of the potential users in the super-categories of the MSKU or at overall e-commerce platform level. The method further includes tagging, by the processor, the MSKU into different types of the MSKU, based on a pre-defined benchmark index and a pre-defined threshold values corresponding to at least one of, the market share of potential users for the MSKU and the benchmarking of the MSKU. The method further includes outputting, by the processor, the tagged potential users and the tagged potential Market Stock Keeping Unit (MSKU) in retail e-commerce environment.

In a second aspect, the present disclosure provides a potentiality identification system for determining potential users and potential Market Stock Keeping Unit (MSKU) in retail e-commerce environment. The system includes a processor, and a memory coupled to the processor. The memory includes processor executable instructions, which in execution causes the processor to receive user data including one or more parameters from a database of a retail e-commerce environment. The one or more parameters includes at least one of a price affinity, a brand, and a mode of payment. The processor is further configured to categorize different types of user based on an affluence segment criteria, upon receiving the user data. The processor is further configured to tag different types of users based on the categorization. The different types of users include at least one of a potential user, an emerging potential user, a mass user, and an entry level user. The processor is further configured to compute a market share of potential users for a Market Stock Keeping Unit (MSKU). The processor is further configured to benchmark the computed market share of potential users for the MSKU with respect to a market share of the potential users in the super-categories of the MSKU or at overall e-commerce platform level. The processor is further configured to tag the MSKU into different types of the MSKU, based on a pre-defined benchmark index and a pre-defined threshold values corresponding to at least one of, the market share of potential users for the MSKU and the benchmarking of the MSKU. The processor is further configured to output the tagged potential users and the tagged potential Market Stock Keeping Unit (MSKU) in retail e-commerce environment.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/subcomponents of each component. It will be appreciated by those skilled in the art that invention of such drawings includes the invention of electrical components, electronic components or circuitry commonly used to implement such components.

FIG. 1 illustrates an exemplary block diagram representation of a network architecture implementing a potentiality identification system for determining potential users and potential Market Stock Keeping Unit (MSKU) in retail e-commerce environment, according to embodiments of the present disclosure;

FIG. 2 illustrates a detailed block diagram representation of the proposed system, according to embodiments of the present disclosure;

FIG. 3 illustrates an exemplary schematic representation of a methodology 300 to categorize users buying a mobile device;

FIG. 4 illustrates a flow chart for a method for determining potential users and potential Market Stock Keeping Unit (MSKU) in retail e-commerce environment, according to an embodiment of the present disclosure; and

FIG. 5 illustrates a hardware platform 500 for implementation of the disclosed system, according to an example embodiment of the present disclosure

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In an aspect, the present disclosure provides a method for determining potential users and potential market stock keeping unit (MSKU) in retail e-commerce environment. The method includes receiving, by a processor associated with a potentiality identification system, user data including one or more parameters from a database of a retail e-commerce environment. The one or more parameters includes at least one of a price affinity, a brand, and a mode of payment. The method further includes categorizing, by the processor, different types of user based on an affluence segment criteria, upon receiving the user data. The method further includes tagging, by the processor, different types of users based on the categorization. The different types of users include at least one of a potential user, an emerging potential user, a mass user, and an entry level user. The method further includes computing, by the processor, a market share of potential users for a Market Stock Keeping Unit (MSKU). The method further includes benchmarking, by the processor, the computed market share of potential users for the MSKU with respect to a market share of the potential users in the super-categories of the MSKU or at overall e-commerce platform level. The method further includes tagging, by the processor, the MSKU into different types of the MSKU, based on a pre-defined benchmark index and a pre-defined threshold values corresponding to at least one of, the market share of potential users for the MSKU and the benchmarking of the MSKU. The method further includes outputting, by the processor, the tagged potential users and the tagged potential Market Stock Keeping Unit (MSKU) in retail e-commerce environment.

In another aspect, the present disclosure provides a potentiality identification system for determining potential users and potential Market Stock Keeping Unit (MSKU) in retail e-commerce environment. The system includes a processor, and a memory coupled to the processor. The memory includes processor executable instructions, which in execution causes the processor to receive user data including one or more parameters from a database of a retail e-commerce environment. The one or more parameters includes at least one of a price affinity, a brand, and a mode of payment. The processor is further configured to categorize different types of user based on an affluence segment criteria, upon receiving the user data. The processor is further configured to tag different types of users based on the categorization. The different types of users include at least one of a potential user, an emerging potential user, a mass user, and an entry level user. The processor is further configured to compute a market share of potential users for a Market Stock Keeping Unit (MSKU). The processor is further configured to benchmark the computed market share of potential users for the MSKU with respect to a market share of the potential users in the super-categories of the MSKU or at overall e-commerce platform level. The processor is further configured to tag the MSKU into different types of the MSKU, based on a pre-defined benchmark index and a pre-defined threshold values corresponding to at least one of, the market share of potential users for the MSKU and the benchmarking of the MSKU. The processor is further configured to output the tagged potential users and the tagged potential Market Stock Keeping Unit (MSKU) in retail e-commerce environment.

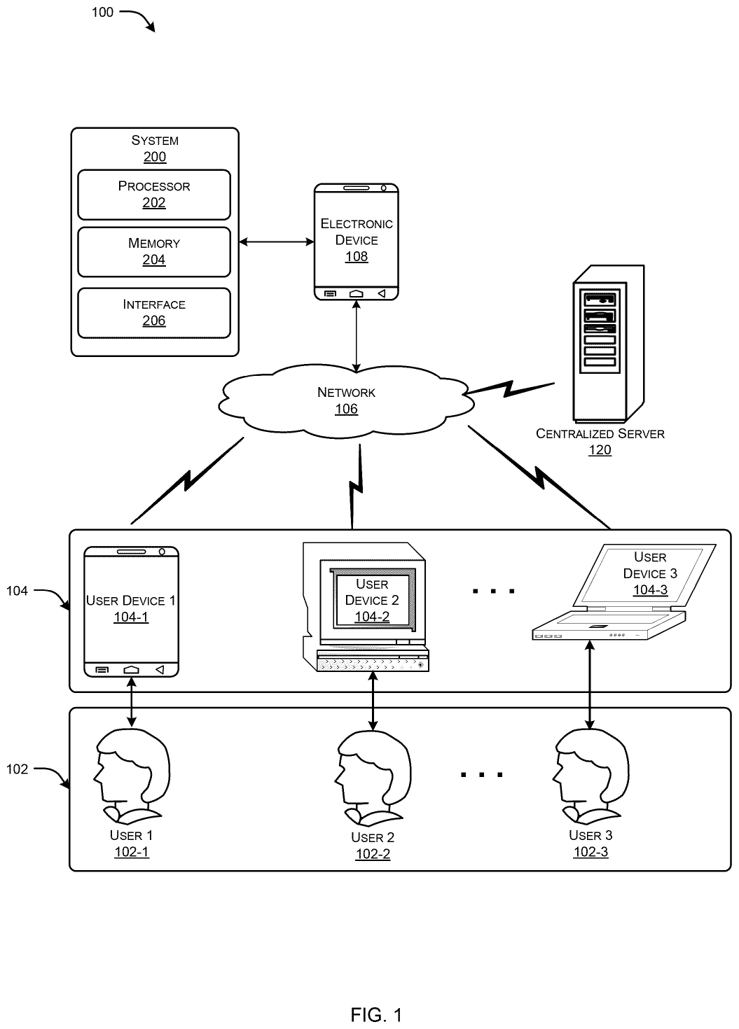

FIG. 1 illustrates an exemplary block diagram representation of a network architecture 100 implementing a potentiality identification system 200 for determining potential users and potential Market Stock Keeping Unit (MSKU) in retail e-commerce environment, according to embodiments of the present disclosure. The network architecture 100 may include the system 200, an electronic device 108, and a server 120. The system 200 may be connected to the server 120 via a communication network 106. The server 120 may include, without limitations, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable to transfer data between entities of that network such as, but are not limited to, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, combinations thereof, and the like.

The system 200 may be implemented by way of a single device or a combination of multiple devices that may be operatively connected or networked together. For instance, the system 200 may be implemented by way of standalone device such as the server 120, and the like, and may be communicatively coupled to the electronic device 108. In another instance, the system 200 may be implemented in the electronic device 108. The electronic device 108 may be any electrical, electronic, electromechanical, and computing device. The electronic device 108 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like.

In some embodiments, the system 200 may be communicably coupled to one or more computing devices 104. The one or more computing devices 104 may be associated with corresponding one or more users 102. For instance, the one or more computing devices 104 may include computing devices 104-1, 104-2 . . . 104-N, associated with corresponding users 102-1, 102-2 . . . 102-N. The one or more computing devices 104 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like.

The system 200 may be implemented in hardware or a suitable combination of hardware and software. Further, the system 110 may include a processor 202, a memory 204, and an interface 206. The interface 206 on the system 200 may be used to receive input from a user.

Further, the system 200 may also include other units such as a display unit, an input unit, an output unit and the like, however the same are not shown in the FIG. 1, for the purpose of clarity. Also, in FIG. 1 only few units are shown, however the system 200 may include multiple such units or the system 200 may include any such numbers of the units, obvious to a person skilled in the art or as required to implement the features of the present disclosure. The system 200 may be a hardware device including the processor 202 executing machine-readable program instructions to determine potential users and potential Market Stock Keeping Unit (MSKU) in retail e-commerce environment. Execution of the machine-readable program instructions by the processor 202 may enable the proposed system 200 to determine potential users and potential Market Stock Keeping Unit (MSKU) in retail e-commerce environment. The “hardware” may include a combination of discrete components, an integrated circuit, an application-specific integrated circuit, a field programmable gate array, a digital signal processor, or other suitable hardware. The “software” may include one or more objects, agents, threads, lines of code, subroutines, separate software applications, two or more lines of code or other suitable software structures operating in one or more software applications or on one or more processors. The processor 202 may include, without limitations, microprocessors, microcomputers, microcontrollers, digital signal processors, central processing units, state machines, logic circuits, any devices that manipulate data or signals based on operational instructions, and the like. Among other capabilities, the processor 202 may fetch and execute computer-readable instructions in the memory 204 operationally coupled with the system 200 for performing tasks such as data processing, input/output processing, feature extraction, and/or any other functions. Any reference to a task in the present disclosure may refer to an operation being or that may be performed on data.

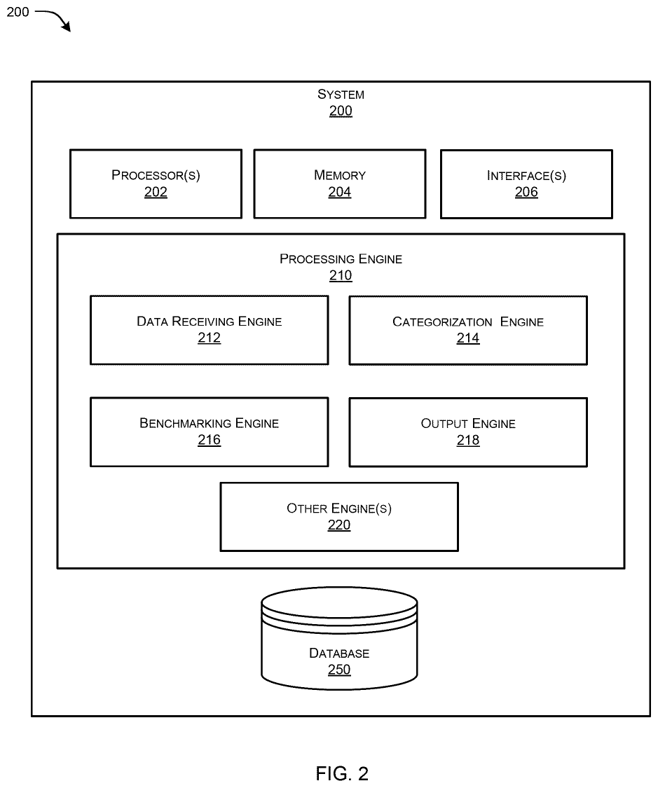

FIG. 2 illustrates a detailed block diagram representation of the proposed system 200, according to embodiments of the present disclosure. The system 200 may include the processor 202, the memory 204, and the interface 206. The system 200 includes a processing engine 210. The processing engine 210 further includes a data receiving engine 212, a categorization engine 214, a benchmarking engine 216, an output engine 218, and other engines 220.

In some embodiments, the system 200 further includes a database 250 storing data. In an embodiment, the data may be stored in the form of various data structures. Additionally, the data can be organized using data models, such as relational or hierarchical data models. The data may further include temporary data and temporary files, generated by the processing engine 210 for performing the various functions of the system 200.

In some embodiments, the database 250 may further include data pertaining to a retail e-commerce environment. The data may include user data.

The processing engine 210 may be stored within the memory 204. In an example, the processing engine 210 communicatively coupled to the processor 202 configured in the system 200, may also be present outside the memory 204, and implemented as hardware. As used herein, the term engine may refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

Referring now to FIGS. 1 and 2, the data receiving engine 212 is configured to receive user data including one or more parameters from the database 250 of the retail e-commerce environment. The one or more parameters includes at least one of a price affinity, a brand, and a mode of payment. In some embodiments, the price affinity includes user insights that classifies the users into different tiers, based on a user browsing behavior on the retail e-commerce environment. In some embodiments, the brand includes highly affluent brands of products. In some embodiments, the mode of payment includes a preferred mode of payment which includes a Cash on Delivery (COD), a debit card, a net banking, a credit card, a gift card, and an electronic wallet.

The categorization engine 214 is configured to categorize different types of user, based on an affluence segment criteria, upon receiving the user data. In some embodiments, the affluence segment criteria include one or more criteria which satisfies at least one of price affinities, a potential brand, a prepaid payment mode, a resting user, a non-potential brand. The categorization engine 214 is further configured to tag different types of users based on the categorization. The different types of users include at least one of a potential user, an emerging potential user, a mass user, and an entry level user.

The benchmarking engine 216 is configured to compute a market share of potential users for a market stock keeping unit (MSKU). The benchmarking engine 216 is further configured to benchmark the computed market share of potential users for the MSKU with respect to a market share of the potential users in the super-categories of the MSKU or at overall e-commerce platform level. The benchmarking engine 216 is further configured to tag the MSKU into different types of MSKU, based on a pre-defined benchmark index and a pre-defined threshold values corresponding to at least one of, the market share of potential users for the MSKU and the benchmarking of the MSKU. In some embodiments, the MSKU is tagged into different types of the MSKU as a potential MSKU which is almost exclusively selected by the potential users, a mid-MSKU which is selected by both potential and non-potential users, a non-potential MSKU which is preferred by non-potential users and selection is low.

The output engine 218 is configured to output the tagged potential users and the tagged potential MSKU in the retail e-commerce environment.

In some embodiments, data related to operations by the processing engine 210 may be configured to be stored in the database 250, or in the memory 204.

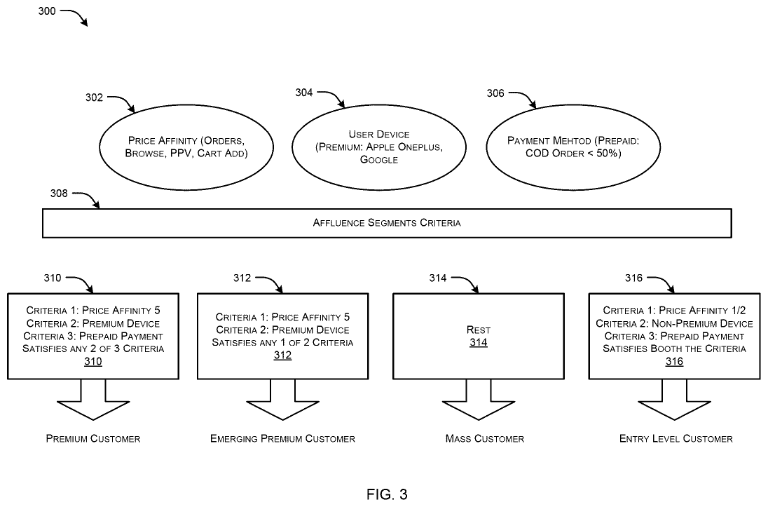

FIG. 3 illustrates an exemplary schematic representation of a methodology 300 to categorize users buying a mobile device. The price affinity 302 of the user is obtained based on past history of the user, which may include browsing history, or past purchases on the retail e-commerce environment, or past selections on the retail e-commerce environment. The brand 304 of the device may be obtained on the selection made by the user. The brands may include premium brands or may include non-premium brands. The mode of payment 306 used by the user is obtained based on selection of the user. The affluence segment criteria 308 is then applied to categorize the user into one of the potential user 310, the emerging potential user 312, the mass user 314, and the entry level user 316.

For example, the price affinity 302 may have tiers 1 through 5, where tier 1 has the lowest price affinity and tier 5 has the highest. Further, brand 304 of the device may be considered premium for brands such as Apple, Google, Samsung, etc. Furthermore, for mode of payment 306, a prepaid means of payment, such as debit card, net banking, credit card, wallet, etc. is preferred.

In the illustrated embodiment of FIG. 3, a potential user 310 is one who has a high price affinity tier (such as tier 4 or 5), is interested in purchasing a premium brand and selects a prepaid means of payment. An emerging potential user 312 is one who has a high price affinity tier (such as tier 4 or 5) and is interested in purchasing a premium brand. The entry level user 316 is one who has a lower price affinity tier (such as tier 1 or 2) and is interested in purchasing a non-premium brand. A user who satisfies any other criteria may be considered a mass user 314.

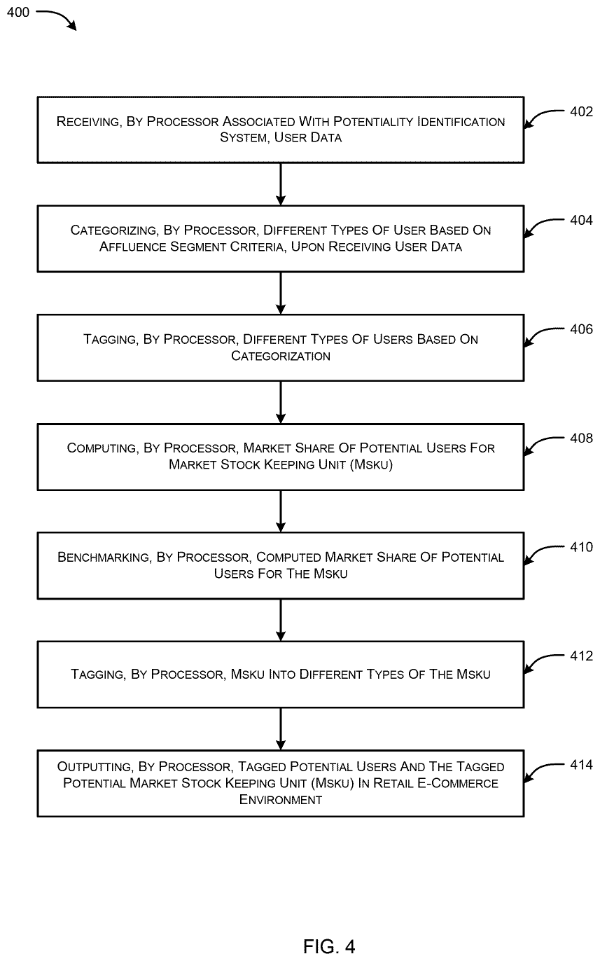

FIG. 4 illustrates a flow chart for a method 400 for determining potential users and potential market stock keeping unit (MSKU) in retail e-commerce environment, according to an embodiment of the present disclosure. At step 402, the method 400 includes receiving, by the processor 202 associated with potentiality identification system 200, user data including one or more parameters from a database of a retail e-commerce environment. The one or more parameters includes at least one of a price affinity, a brand, and a mode of payment. At step 404, the method 400 further includes categorizing, by the processor 202, different types of user based on an affluence segment criteria, upon receiving the user data. At step 406, the method 400 further includes tagging, by the processor 202, different types of users based on the categorization. The different types of users include at least one of a potential user, an emerging potential user, a mass user, and an entry level user. At step 408, the method 400 further includes computing, by the processor 202, a market share of potential users for a Market Stock Keeping Unit (MSKU). At step 410, the method 400 further includes benchmarking, by the processor 202, the computed market share of potential users for the MSKU with respect to a market share of the potential users in the super-categories of the MSKU or at overall e-commerce platform level. At step 412, the method 400 further includes tagging, by the processor 202, the MSKU into different types of the MSKU, based on a pre-defined benchmark index and a pre-defined threshold values corresponding to at least one of, the market share of potential users for the MSKU and the benchmarking of the MSKU. At step 414, the method 400 further includes outputting, by the processor 202, the tagged potential users and the tagged potential Market Stock Keeping Unit (MSKU) in retail e-commerce environment.

The order in which the method 400 are described is not intended to be construed as a limitation, and any number of the described method blocks may be combined or otherwise performed in any order to implement the method 400 or an alternate method. Furthermore, the method 400 may be implemented in any suitable hardware, software, firmware, or a combination thereof, that exists in the related art or that is later developed. The method 400 describe, without limitation, the implementation of the system 200. A person of skill in the art will understand that method 400 may be modified appropriately for implementation in various manners without departing from the scope and spirit of the disclosure.

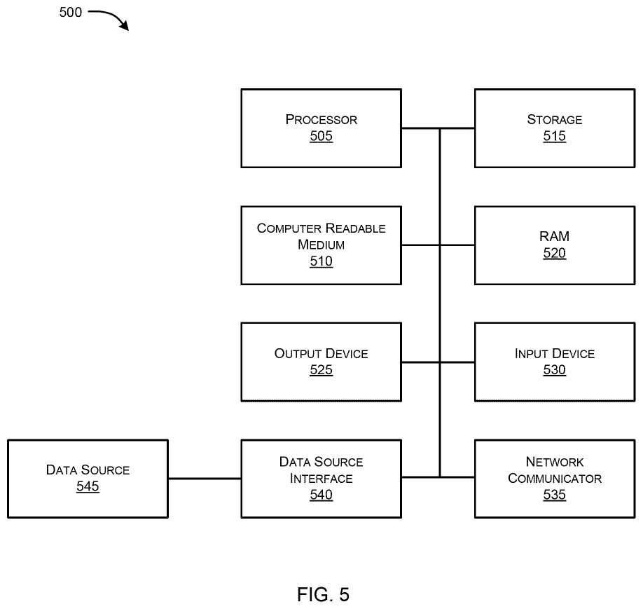

FIG. 5 illustrates a hardware platform 500 for implementation of the disclosed system 200, according to an example embodiment of the present disclosure. For the sake of brevity, construction, and operational features of the system 200 which are explained in detail above are not explained in detail herein. Particularly, computing machines such as but not limited to internal/external server clusters, quantum computers, desktops, laptops, smartphones, tablets, and wearables which may be used to execute the system 200 or may include the structure of the hardware platform 500. As illustrated, the hardware platform 500 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 500 may be a computer system such as the system 200 that may be used with the embodiments described herein. The computer system may represent a computational platform that includes components that may be in a server or another computer system. The computer system may execute, by the processor 505 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and documents and analyze documents. In an example, the processing engine 210 may be software codes or components performing these steps.

The instructions on the computer-readable storage medium 510 are read and stored the instructions in storage 515 or in random access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interact with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for instance. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE INVENTION

The present invention provides a system and a method for determining potential users and market stock keeping unit in retail e-commerce environment.

The present invention provides a system and method for categorizing users to better understand user behaviour and preferences.

The present invention provides a system and method to more accurately determine user behaviour and preferences.

We claim:

1. A method for determining potential users and potential Market Stock Keeping Unit (MSKU) in retail e-commerce environment, the method comprising:
receiving, by a processor associated with a potentiality identification system, user data comprising one or more parameters from a database of a retail e-commerce environment, wherein the one or more parameters comprises at least one of a price affinity, a brand, and a mode of payment;
categorizing, by the processor, different types of user based on an affluence segment criteria, upon receiving the user data;
tagging, by the processor, different types of users based on the categorization, wherein the different types of users comprise at least one of a potential user, an emerging potential user, a mass user, and an entry level user;
computing, by the processor, a market share of potential users for a Market Stock Keeping Unit (MSKU);
benchmarking, by the processor, the computed market share of potential users for the MSKU with respect to a market share of the potential users in the super-categories of the MSKU or at overall e-commerce platform level;
tagging, by the processor, the MSKU into different types of the MSKU, based on a pre-defined benchmark index and a pre-defined threshold values corresponding to at least one of, the market share of potential users for the MSKU and the benchmarking of the MSKU; and
outputting, by the processor, the tagged potential users, and the tagged potential Market Stock Keeping Unit (MSKU) in retail e-commerce environment.

2. The method as claimed in claim 1, wherein the price affinity comprises user insights that classifies the users into different tiers, based on a user browsing behavior on the e-commerce environment.

3. The method as claimed in claim 1, wherein the brand comprises highly affluent brands of products, and wherein the mode of payment comprises a preferred mode of payment which comprises a Cash on Delivery (COD), a debit card, a net banking, a credit card, a gift card, and an electronic wallet.

4. The method as claimed in claim 1, wherein the affluence segment criteria comprise one or more criteria which satisfies at least one of the price affinities, a potential brand, a prepaid payment mode, a resting user, a non-potential brand.

5. The method as claimed in claim 1, wherein the MSKU is tagged into different types of the MSKU as a potential MSKU which is almost exclusively selected by the potential users, a mid-MSKU which is selected by both potential and non-potential users, a non-potential MSKU which is preferred by non-potential users and selection is low.

6. A potentiality identification system for determining potential users and potential Market Stock Keeping Unit (MSKU) in retail e-commerce environment, the potentiality identification system comprising:
a processor;
a memory coupled to the processor, wherein the memory comprises processor executable instructions, which in execution causes the processor to:
receive user data comprising one or more parameters from a database of a retail e-commerce environment, wherein the one or more parameters comprises at least one of a price affinity, a brand, and a mode of payment;
categorize different types of user based on an affluence segment criteria, upon receiving the user data;
tag different types of users based on the categorization, wherein the different types of users comprise at least one of a potential user, an emerging potential user, a mass user, and an entry level user;
compute a market share of potential users for a Market Stock Keeping Unit (MSKU);
benchmark the computed market share of potential users for the MSKU with respect to a market share of the potential users in the super-categories of the MSKU or at overall e-commerce platform level;
tag the MSKU into different types of the MSKU, based on a pre-defined benchmark index and a pre-defined threshold values corresponding to at least one of, the market share of potential users for the MSKU and the benchmarking of the MSKU; and
output the tagged potential users and the tagged potential Market Stock Keeping Unit (MSKU) in retail e-commerce environment.

7. The potentiality identification system as claimed in claim 6, wherein the price affinity comprises user insights that classifies the users into different tiers, based on a user browsing behavior on the e-commerce environment.

8. The potentiality identification system as claimed in claim 6, wherein the brand comprises highly affluent brands of products, and wherein the mode of payment comprises a preferred mode of payment which comprises a Cash on Delivery (COD), a debit card, a net banking, a credit card, a gift card, and an electronic wallet.

9. The potentiality identification system as claimed in claim 6, wherein the affluence segment criteria comprise one or more criteria which satisfies at least one of the price affinities, a potential brand, a prepaid payment mode, a resting user, a non-potential brand.

10. The potentiality identification system as claimed in claim 6, wherein the MSKU is tagged into different types of the MSKU as a potential MSKU which is almost exclusively selected by the potential users, a mid-MSKU which is selected by both potential and non-potential users, a non-potential MSKU which is preferred by non-potential users and selection is low.
